(19) United States
(12) Patent Application Publication
(10) Pub. No.: US 2011/0133577 A1
(43) Pub. Date: Jun. 9, 2011

(54) HORIZONTAL LINEAR VIBRATION DEVICE

(75) Inventor: In Ho Lee, Gyeonggi-do (KR)

(73) Assignees: In Ho LEE, Yongin-si, Gyeonggi-do (KR); LEMOTRON CO., LTD, Yongin-si, Gyeonggi-do (KR)

(21) Appl. No.: 13/059,459

(22) PCT Filed: Aug. 18, 2009
(86) PCT No.: PCT/KR09/04601

§ 371 Date: Feb. 17, 2011

(30) Foreign Application Priority Data
Aug. 18, 2008 (KR) 10-2008-0080285
Aug. 18, 2008 (KR) 10-2008-0080585
Oct. 27, 2008 (KR) 10-2008-0105513
Feb. 4, 2009 (KR) 10-2009-0008697
Feb. 4, 2009 (KR) 10-2009-0008698
Feb. 17, 2009 (KR) 10-2009-0012735
Feb. 17, 2009 (KR) 10-2009-0012739
Mar. 6, 2009 (KR) 10-2009-0019056
Apr. 20, 2009 (KR) 10-2009-0034340
May 7, 2009 (KR) 10-2009-0039685
May 28, 2009 (KR) 10-2009-0046737
May 28, 2009 (KR) 10-2009-0046739
Jun. 9, 2009 (KR) 10-2009-0051113
Jul. 2, 2009 (KR) 10-2009-0060054
Jul. 28, 2009 (KR) 10-2009-0068607
Aug. 10, 2009 (KR) 10-2009-0073400

(51) Int. Cl. H02K 33/02

(52) U.S. Cl. 310/15

(57) ABSTRACT

The present invention provides a horizontal vibration device which comprises an upper case in which a spring connector is formed in the inner surface thereof and a lower case which is coupled with the upper case to form an internal space, a movable unit including a mass which horizontally reciprocates inside the case and a spring which is coupled between the case and the mass in order to support horizontal movement of the mass, a coil which is coupled with the mass and horizontally reciprocates together with the mass, a magnet which is fastened on the inner surface of the case and operates with the coil, and a power-supply unit which supplies power to the coil.

### TECHNICAL FIELD

The present invention relates to a vibration motor that is mounted inside an electronic appliance, such as a mobile communication terminal or a game station, and more particularly, to a horizontal vibration device that has a coil attached to a mass, and generates vibration while performing a horizontal reciprocal motion.

### BACKGROUND ART

In general, one of the functions that are essentially required for a communication device is a call-receiving function. For the call-receiving function, a sound-generating function, which generates a melody, a bell, or the like, and a vibration function, which vibrates the communication device, are generally used. Of these functions, the vibration function is mainly used when the user intends to prevent the melody or bell from being transmitted to the outside through the speaker, so that it does not disturb other people. In order to produce, such vibration, a small vibration device is typically operated to transmit a driving force to the case of the communication device so that the communication device vibrates. In addition, as the distribution of mobile phones with touch screens has been increasing, recently the vibration device is required to provide virtual tactile sensations to the user in addition to the call-receiving function, which simply replaces the melody.

Vibration devices that are currently applied to mobile phones can be divided into rotational vibration devices and linear vibration devices. In a rotational vibration device, the volume of the rotor is increased or the number of rotations is increased in order to increase vibration force. However, a rotational vibration device is limited in the extent to which its size can be reduced due to a structural problem, and thus has difficulty in generating strong vibration.

The linear vibration device is configured so that a vibrator moves vertically up and down to generate a vibration force. In response to recent trends in the distribution of electronic devices toward a thinner profile, mobile phones are required to have a thin profile. However, the vertical linear vibration device of the related art has a disadvantage in that its vibration level significantly decreases when its thickness is reduced. This is caused by the characteristics of the linear vibration device; i.e., the amount of vibration is proportional to the distance that the vibrator moves. So, in a vertical linear vibration device, as the thickness of the mobile phone decreases, the distance that the vibrator moves significantly decreases and thus the amount of vibration greatly decreases.

In addition, as shown in FIG. 41, a vertical linear vibration device uses a leaf spring, which was proposed in Korean Patent Application Publication 10-2005-0083528. This vertical linear vibration device is configured so that a leaf spring 330 is welded to a case 310 and a moving unit 320, which leads to the frequent occurrence of problems in that welding defects frequently occur, and the leaf spring is deformed or is separated at the welded portion from the case due to impact, which is caused when a product drops, or due to external impact.

Unlike the foregoing vertical linear vibration device, a horizontal linear vibration device was proposed in Japanese Patent Application Publication No. 2003-117489. This horizontal linear vibration device is shown in FIG. 42, and will be described as follows:

A cylindrical frame 410 has a pair of brackets holding both ends of a support shaft, and a cylindrical coil 420 is fixedly coupled to the inner circumference of the frame. This is configured so that a cylindrical magnet 430 is coupled together with the support shaft, and the magnet reciprocally moves due to the electromagnetic interaction between the coil and the magnet, thereby generating vibration.

If a magnetic material is placed in a time-varying magnetic field, iron loss occurs due to the magnetic material. The iron loss is a value obtained by adding hysteresis loss, which corresponds to the area of the hysteresis curve of the magnetic material, with eddy current loss, which occurs in the magnetic material.

The horizontal linear vibration device proposed in Japanese Patent Application Publication No. 2003-117489 is configured so that the coil is fixed to the inner portion of the case and the magnet is designed to reciprocally move by being coupled to the moving unit. The magnet generates a time-varying magnetic field inside the vibration device while performing a reciprocal motion, and creates iron loss in the magnetic material, such as the case, which is placed in the time-varying magnetic field. The iron loss not only causes power loss, but also obstructs rapid responsibility of the vibration device. Recently, rapid responsibility is very important for mobile phones equipped with a touch screen structure. However, the structure in which the magnet reciprocally moves has a problem in that it fails to satisfy recent performance requirements for electronic devices such as mobile phones, due to its slow responsibility.

### DISCLOSURE

### Technical Problem

Accordingly, the present invention has been made keeping in mind the above problems occurring in the prior art, and an object of the present invention is to provide a vibration device that is configured so that a mass of a moving unit vibrates horizontally rather than vertically, whereby a product fitted with the vibration device can have a slim profile.

Another object of the present invention is to provide a vibration device, in which a coil is coupled to a mass so that the coil performs a horizontal reciprocal motion, thereby removing iron loss, minimizing power loss, and improving responsibility.

A further object of the present invention is to provide a vibration device, in which a support shaft is omitted and a mass is supported by only a spring so that it can reciprocally move, thereby reducing the manufacturing costs of the support shaft and the bearing, simplifying assembly and fabrication processes, and improving productivity.

Yet another object of the present invention is to provide a vibration device, in which a guide and a preventive member are provided such that a mass can easily perform a reciprocal motion, thereby preventing friction noise and frictional abrasion of the case.

Still another object of the present invention is to provide a vibration device, in which a variety of vibration patterns can be realized using a plurality of moving units and a controller that individually controls the moving units.

### Technical Solution

In order to accomplish the above objects, the present invention provides a horizontal vibration device that includes an upper case having a spring connector in the inner surface thereof and a lower case, the lower case being coupled to the upper case to define a space therein; a moving unit including a mass for performing a horizontal reciprocal motion inside the upper and lower cases and springs coupled between the upper and lower case and the mass to support a parallel motion of the mass; a coil coupled to the mass to perform a horizontal reciprocal motion along with the mass; magnets fixedly coupled to the inner surfaces of the upper and lower cases to interact with the coil; and a power supply for supplying power to the coil.

The upper case may include a cover and a bracket.

The upper case and the lower case may be “U” shaped, and be coupled in a staggered arrangement by an interactive force between the magnets coupled to the upper case and the lower case.

The upper case and the lower case may be provided with a coupling protrusion and a coupling recess.

Spring connectors may be formed on the front and rear surfaces of the mass.

The mass may have a guide groove therein, and the horizontal vibration device may further include a guide coupled to the guide groove.

The mass may have a protrusion-shaped guide thereon.

The guide may be coupled in a direction parallel to the direction in which the mass moves.

The guide may be coupled in a direction perpendicular to the direction in which the mass moves.

The guide may be bar shaped or spherical.

The guide may be integrated to the mass.

The horizontal vibration device may further include a preventive member for preventing friction and resultant noise between the mass and the inner surfaces of the upper and lower cases.

The coil may be coupled to one or both sides of the mass via a fixing member so that the coil is parallel to the bottom surface of the lower case, and the magnets are coupled so as to face the coil.

The magnet may be coupled to the inner surfaces of the upper and lower cases, and a pair of the magnets are arranged above and below the coil.

One of the pair of the magnets may be a magnetic material.

The coil may be coupled to both sides of the mass so as to be parallel to the bottom surface of the lower case, and the magnets are coupled so as to face the coil.

The horizontal vibration device may further include a plate coupled between the coil and the mass to interrupt lines of magnetic force that are generated by the coil.

The plate may be a magnetic material.

The power supply may include an external power board connected to an external power source, a coil-connected board installed on the mass and electrically connected to the coil, and a brush electrically connecting the external power board to the coil-connected board.

The brush may include a flat fixing portion fixed to the external power board, an arc-shaped bent beginning from one end of the fixing portion, and a contact having a plurality of prongs, the contact being in contact with the coil-connected board.

An arc defined by the bent may have an angle of circumference ranging from 90° to 180°.

The horizontal vibration device may further include a fixing member fixing the coil to the mass, and a damper for preventing the coil or the mass from colliding into the case.

A plurality of the moving units may be provided, and the coil may be coupled to one portion of the outermost one of the masses.

A plurality of the moving units may be provided, and the coil may be coupled between the masses through a fixing member.

The horizontal vibration device may further include a controller for individually controlling the moving units, in which the masses are individually moved by the controller.

Springs included in the moving units may be integrally formed.

The power supply may include a spring-connected board electrically connected to a spring to supply external power to the coil through the spring, and a coil-connected board coupled to the mass and electrically connected to the coil.

The spring-connected board may have a “U” shape, with both end portions thereof being bent, and be coupled to the inner surfaces of the upper and lower cases.

The spring may have protruding both ends, by which the spring is easily in contact with patterns of the spring-connected board and the coil-connected board

The horizontal vibration device may further include a spring support protrusion coupled to the upper case to support the spring, and the spring support protrusion may be made of a resin material that insulates the spring and the upper case.

The power supply may include an external power board connected to an external power source, a coil-connected board installed on the mass and electrically connected to the coil, and an elastic spring. One end of the elastic spring is connected to the external power board, and the other end of the elastic spring is connected to the coil-connected board.

The external power board may have two pattern lines having different lengths, one end of the pattern line being positioned collinear with one end of the pattern line.

The elastic spring may be made of carbon steel.

The power supply may include an external board connected to an external power source, and an elastic circuit board. A portion of the elastic circuit board is fixedly connected to the mass, and the elastic circuit board supplies external power that is supplied through the external board to the coil.

The elastic circuit board may have layer films attached to both surfaces thereof in order to protect a pattern thereof.

The power supply may include a spring-connected board electrically connected to a spring to supply external power to the mass through the spring. The mass is electrically connected to the spring, so that the external power that is supplied through the spring is supplied to the coil through the mass.

The mass may is a conductor.

The spring-connected board may include a connecting portion and an interrupting portion, and be coupled to the inner surfaces of the upper and lower cases.

Both ends of the coil may be connected to the mass by soldering or thermal fusion.

### ADVANTAGEOUS EFFECTS

The present invention has an advantage in that a product fitted with the vibration device can have a slim profile, since the vibration device is configured so that the mass of the moving unit vibrates horizontally rather than vertically.

In addition, there are advantages of removing iron loss, minimizing power loss, and improving responsibility, since the coil is coupled to the mass so that the coil performs a horizontal reciprocal motion.

Furthermore, there are advantages of reducing the manufacturing costs of the support shaft and the bearing, simplifying assembly and fabrication processes, and improving productivity, since the support shaft is omitted and the mass is supported by only the spring so that it can reciprocally move.

In addition, there are advantages of preventing friction noise and frictional abrasion of the case, since the guide and the preventive member are provided so that the mass can easily perform a reciprocal motion.

Furthermore, there are advantages in that a variety of vibration patterns can be realized using the multiple moving units and the controller that individually controls the moving units.

### DESCRIPTION OF DRAWINGS

FIG. 1 is a front elevation view showing a horizontal vibration device according to an exemplary embodiment of the invention,

FIG. 2 is a top plan view of the horizontal vibration device shown in FIG. 1 from which the cover is removed,

FIG. 3 is a view showing the upper inner surface of the cover of the horizontal vibration device shown in FIG. 1, and

FIG. 4 is a view showing the brush;

FIGS. 5 to 7 are views showing a modified embodiment of the guide;

FIG. 8 is a view showing an arrangement in which a coil is coupled to the upper and lower portions of the mass;

FIGS. 9 to 40 is a view showing horizontal vibration devices according to other exemplary embodiments of the invention; and

FIGS. 41 to 42 are views showing a vibration device of the related art.

### BEST MODE

Reference will now be made in greater detail to exemplary embodiments of the invention with reference to the accompanying drawings. Prior to offering the description, it is noted that terms or words expressed in the specification and claims should not be limited to or construed by their conventional or dictionary meanings, but should be understood as meanings and concepts conforming with the technical principles of the present invention because the inventor can properly define the concepts of terms or words used in order to clarify his/her invention in the best manner.

However, the embodiments described herein and the accompanying drawings are merely most preferred examples of the invention, but do not present all of the technical principles of the invention. Therefore, it should be understood that various equivalents and modifications, which can replace these embodiments, could be present at the time the present invention was made.

Hereinafter, various embodiments of a horizontal vibration device of the invention will be described more fully with reference to the accompanying drawings.

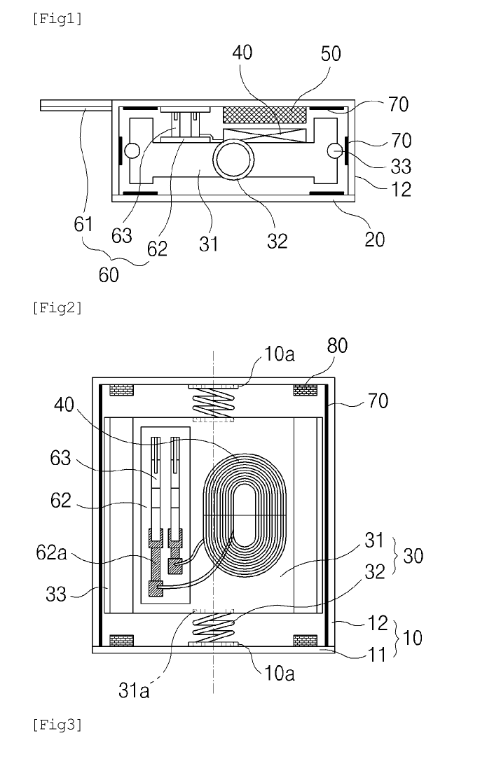

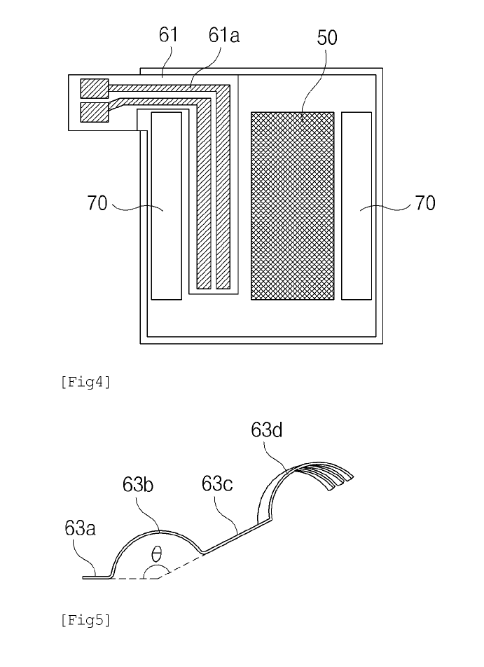

FIG. 1 is a front elevation view of a horizontal vibration device according to an exemplary embodiment of the invention, and FIG. 2 is a top plan view of the horizontal vibration device shown in FIG. 1 from which the cover is removed.

An upper case 10 and a lower case 20 are coupled to each other so that they define a space therein. The upper case 10 includes the cover 12 and a bracket 11. The cover 12 has a rectangular parallelepiped structure with the underside and front sides being open, and the bracket 11 is coupled to the front side of the cover that is open.

Spring connectors 10, to which springs 32 are coupled, are formed on the inner surface of the bracket 11 and on the inner surface of the rear side of the cover 12. The spring connectors 10a can be a protrusion or a recess. The upper case 10 consisting of the bracket 11 and the cover 12 realizes an advantage in that assembly is easy when coupling a mass 31 and the springs 32 to the upper case.

Respective sides of the upper case 10 and respective sides of the lower case 20 are preferably defined so that they are rectangular, and the two cases 10 and 20 are coupled to each other, thereby producing a rectangular parallelepiped structure having a space therein.

If the case of the horizontal vibration device has a cylindrical shape like a coin or bar type vibration device, it is difficult to balance the device using the springs, which are coupled to the right and left sides of the mass. In addition, if the case has a rectangular parallelepiped shape, there are advantages in that internal components can be easily arranged and the vibration device can have a slim profile.

The bracket 11 and the cover 12, which constitute the upper case 10, can be integrated with each other.

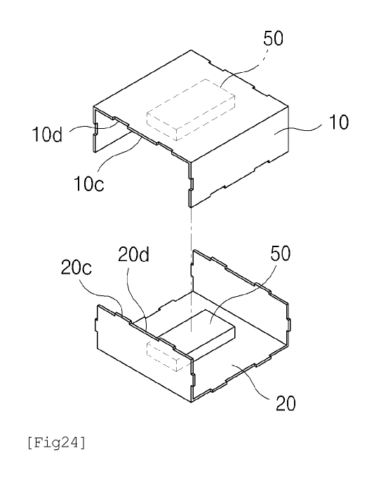

Referring to FIG. 23, the upper case 10 and the lower case 20 can have a “U” shaped structure. Magnets 50 are fixedly coupled to respective inner surfaces of the upper case 10 and the lower case 20. Since the magnets 50 are arranged to face each other, an attracting force is induced between the two magnets 50, and the magnets 50 can be coupled in a staggered arrangement by the attracting force. It is preferred that the upper case 10 and the lower case 20 be provided with coupling protrusions 10c and 20c and coupling recesses 10d and 20d so that they are not in a staggered arrangement when the upper and lower cases 10 and 20 are coupled to each other.

The upper and lower cases 10 and 20 are coupled to each other due to the attracting force of the magnets 50. Therefore, there is an advantage in that the fabrication process can be simplified since assembly is simple and an additional screw engagement is not necessary.

A moving unit 30 is constituted of the mass 31 and the springs 32.

The mass 31 performs horizontal reciprocal motion since the cases 10 and 20 are due to an electromagnetic action between a coil 40 and the magnets 50. It is preferred that the mass 31 be made of tungsten. Tungsten has great inertial mass, since its density is high compared to other materials. Therefore, tungsten can produce a greater amount of vibration than other materials.

One end of one of the springs 32 is coupled to the front surface and one end of the other one of the springs 32 is coupled to the rear surface of the mass 31. Each spring 32 can be coupled to the mass 31 using an adhesive or the like. Preferably, the mass 31 is provided with spring connectors 31a on the front and rear surfaces thereof so that the springs 32 are fixedly coupled to the spring connectors 31a. It is preferred that the spring 32 is coupled to the spring connector 31a in order to provide reliability. The spring connector 31a can be a protrusion or a recess. The mass 31 has an “I” shaped cross-section in order to realize the maximum amount of inertial mass in a limited space. The cross-section of the mass 31 can, of course, be modified into various shapes such as a polygon, including a quadrangle.

Guide grooves are formed in side surfaces of the mass 31, and guides 33 are coupled to the guide grooves. The guides 33 serve to maintain a predetermined interval between the mass 31 and the case 10 and a predetermined interval between the mass 31 and the case 20 in order to facilitate the movement of the mass 31 and prevent the mass 31 from colliding into the case 10 or 20.

It is preferred that the guides 33 have the form of a bar, be coupled in a direction parallel to the direction in which the mass 31 moves, and be coupled along the central portions of the side surface of the mass 31.

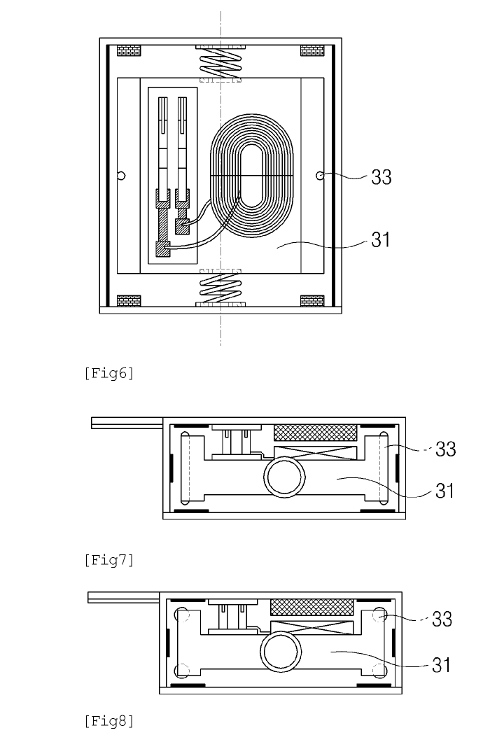

Referring to FIGS. 5 and 6, the guides 33 can be coupled in a direction perpendicular to the direction in which the mass 31 moves. In this case, it is preferred that the guides 33 be coupled on the central portions of both side surfaces of the mass 31, in a direction perpendicular to the bottom surface of the lower case 20.

Referring to FIG. 7, the guides 33 can have the form of a sphere. In this case, the guides 33 can be coupled to the upper and lower portions of a side edge of the mass 31.

It is preferred that the guides 33 maintain predetermined intervals from the cases 10 and 20 so that they do not interrupt the reciprocal motion of the mass 31.

The guides 33 can be integrated to the mass 31 instead of the configuration in which the guide grooves are additionally formed. That is, the guides 33 can be added in the form as protrusions to the mass 31.

In addition, the guides 33 can be formed on the upper and lower surfaces of the mass, and one mass 31 can, of course, be provided with a plurality of guides.

Although a support shaft was used in the related art to order to support the mass and induce the reciprocal motion, the present invention omits the support shaft and uses only the spring to support the mass and realize the reciprocal motion. This, consequently, reduces the manufacturing costs of the support shaft and bearings and simplifies assembly and fabrication processes, thereby improving the efficiency of manufacture. In addition, it is possible to solve the problem in that the space into which the support shaft can be inserted is limited if the mass is thin. Furthermore, it is possible to solve the problem in that the space, such as a hole, into which the support shaft can be inserted, must be provided in order to insert the support shaft into it and the formation of the space reduces the amount of vibration due to decreased inertial mass of the mass.

In addition, the horizontal vibration device according to an exemplary embodiment of the invention exhibits reduction in residual vibration and thus very rapid response time compared to the vibration devices of the related art.

In the following, Reference FIG. 1 is a graph showing residual vibration of a vibration device disclosed in Patent Application Publication No. 10-2005-0083528, and Reference FIG. 2 is a graph showing residual vibration of the vibration device according to an exemplary embodiment of the invention.

Referring to Reference FIG. 1 above, the residual vibration continues for 500 ms in the vibration device of the related art after power is switched off. In contrast, as shown in Reference FIG. 2, in the horizontal vibration device according to an exemplary embodiment of the invention, the residual vibration is completely extinguished for about 60 ms to 70 ms.

These effects of the invention are obtained since, after power is off, the mass can rapidly slow down or stop with assistance of a frictional force that occurs in response to the contact between the guides, which are provided in the mass, and preventive members. More specifically, in the state in which power is supplied, the mass performs a reciprocal motion while having substantially no contact with the preventive members due to an electromagnetic force acting between the magnets and the coil, which are attached to the mass. However, if power is no longer supplied to the coil, the mass sags down under the gravity, so that the guides on the mass are brought into friction with the preventive members while the mass is still reciprocally moving. Therefore, the frictional force contributes to the rapid braking of the reciprocal motion of the mass.

The horizontal vibration device according to an exemplary embodiment of the invention exhibits rapid response time to an input, since its residual vibration is greatly reduced compared to the vibration device of the related art. In haptic mobile phones, the vibration device of the related art has a problem in that vibration due to a first input is not rapidly extinguished and thus overlaps or interferes with vibration due to the next input. In contrast, the vibration device according to an exemplary embodiment of the invention can provide clearer tactile sensation to a user, since vibration due to a first input is rapidly extinguished and thus does not overlap or interfere with vibration due to the next input.

The springs 32 are attached to the front and rear surfaces of the mass 31, respectively. Specifically, one of the springs 32 is coupled between the bracket 11 and the mass 31 and the other one of the springs 32 is coupled between the rear surface of the cover 12 and the mass 31. The springs 32 serve to fix the mass 31 so that the mass 31 is positioned in the center of the inner space of the cases 10 and 20 and to apply an elastic force to the mass 31 so that the mass 31 can perform a reciprocal motion. The springs can be a leaf spring or a helical spring, and preferably are a cylindrical or conical helical spring.

The preventive members 70 prevent friction noise and frictional abrasion, which would otherwise occur when the guides 33 and the mass 31 collide against the inner surfaces of the cases 10 and 20 due to external impact or the like.

The preventive members 70 are attached to the inner surfaces of the upper case 10 and the lower case 20. The preventive members 70 can be formed by a variety of methods.

The preventive members 70 can be a thin film layer, which is made of lubricant, or a fluoride resin coating. The preventive members 70 can also be formed using a fluoride resin tape belonging to a polyimide group. In addition, a method of applying oil or grease after forming a film layer can be used.

Dampers 80 are members that prevent the mass 31 from colliding into the case 10 or 20 due to external impact or the like. The dampers 80 are coupled to the inner surface of the cover 12 and the inner surface of the bracket 11.

In the horizontal vibration device having a plurality of moving units, which will be described later, it is preferred that the dampers 80 be coupled to positions corresponding to fixing members (in the case in which the coil is coupled via the fixing members) or the coil (in the case in which the coil is coupled using adhesive) in order to prevent the fixing member or the coil from colliding into the case.

The coil 40 is a member through which current flows when power is supplied from an external power source. Since alternating current flows across a magnetic field generated from the magnets 50, a reciprocal motion following the Lorenz formula is realized.

The coil 40 can be coupled to the upper portion of the mass 31.

The magnets 50 perform an electromagnetic reaction with the coil 40 by generating a magnetic field, thereby driving the coil 40 to move. The magnets 50 are arranged so that they face the coil 40, and are fixedly coupled to the inner upper surface of the upper case 10.

The intensity of the magnetic field and the force acting on the mass vary depending on the number of coils and magnets. Therefore, as shown in FIG. 8, two coils 2 can be coupled to one mass 31, and two magnets 50 can be provided so that they can face the coils 40.

The linear vibration device of the related art is configured to perform a reciprocal motion, with the coil fixed to the inner portion of the case and the magnet coupled to the moving unit. Here, the magnet forms a time-varying magnetic field throughout the inside and outside of the vibration device while performing a horizontal reciprocal motion, and causes iron loss to magnetic materials, such as the case and the mass, which are placed across the time-varying magnetic field. Such iron loss causes problems in that power is lost and the rapid responsibility of the vibration device cannot be realized.

According to an exemplary embodiment of the invention, the structure in which the coils 40 are attached to the mass 31 and the magnets 50 are fixed to the inner portion of the cases 10 and 20 is provided, so that the coils 40 coupled to the mass 31 can perform a horizontal reciprocal motion, thereby minimizing iron loss, which would otherwise occur in the cases 10 and 20 and the mass 31. The iron loss is proportional to maximum magnetic flux density. Since magnetic flux density generated by the coils, through which current flows, is very much smaller than that generated by the magnets 50, the horizontal vibration device according to an exemplary embodiment of the invention can minimize the iron loss and the power loss due to the iron loss, and realize rapid response time of the vibration device.

A power supply is a component that supplies power to the coils. Unlike a structure in which a coil is fixedly coupled to a case, a vibration device, in which a coil is coupled to a mass to perform a horizontal reciprocal motion together with the mass as in the present invention, requires an additional power supply.

FIG. 3 is a rear view of the cover 12 of the upper case 10, which shows an external power circuit board 61, and FIG. 4 is a view showing a brush 63.

A power supply 60 includes the external power circuit board 61 connected to an external power source, a coil-connected board 62, and brushes 63.

The external power circuit board 61 has defined therein two pattern lines 61a, which are connected to a positive electrode of the external power source, and is fixedly coupled to the upper inner surface of the upper case 10. Each of the ends of the pattern lines 61a is electrically connected to each of both ends of the coil 40. Both ends of the coil 40 can be coupled to the pattern lines 62a by soldering or thermal fusion.

The brushes 63 serve to electrically connect the external power circuit board 61 to the coil-connected board 62. The brushes 63 can continuously supply power to the coil 40 through slide contact with the two pattern lines 61a that are formed on the external power circuit board 61 when the mass performs a horizontal reciprocal motion. The brushes 63 can be fixedly coupled to one of the coil-connected board 62 or the external power circuit board 61.

Referring to FIG. 4, each brush 63 includes a fixing portion 63a, a bent 63b, an extension 63c, and a contact 63d. The fixing portion 63a has a flat shape, and is electrically connected to the pattern lines 61a of the external power circuit board 61. The bent 63d begins from the end of the fixing portion 63a, and has the form of an arc. The angle of circumference θ of the arc ranges from 90° to 180°, and preferably is of the order of 135°. The extension 63c begins from the end of the bent 63b, and has the form of a straight line with an angle of upward inclination. The extension 63d has a plurality of prongs, and is electrically connected to the pattern lines 62a of the coil-connected board 62. Since mobile phones are following a trend toward a slimmer profile, the thickness of vibration devices that are mounted to mobile phones must be reduced. The brush 63 has defined therein the bent 63b having the form of an arc beginning from the fixing portion 63a, and the overall height and the elastic force of the brush can be adjusted by changing the angle of circumference θ of the bent 63b. In addition, since the angle of circumference θ of the bent 63b is defined in the range from 90° to 180°, it is possible to reduce the overall thickness while maintaining the elastic force of the brush. Therefore, this provides an advantage in that a vibration device having a thin profile can be fabricated.

The external power circuit board 61 and the coil-connected board 62 can be a hard board or a flexible board.

The external power circuit board 61 of the power supply 60 can, of course, be coupled to the bottom surface of the lower case 20 according to the environment in which they are used, and the coil-connected board 62 can be consequently coupled to the lower portion of the mass 31.

Descriptions will be given below of other embodiments of the invention. First, it is made clear that the following embodiments are configured so that the coil-connected board 31 is coupled to the lower portion of the mass 31, and additional descriptions of the power supply 60 and overlapping components and functions will be omitted.

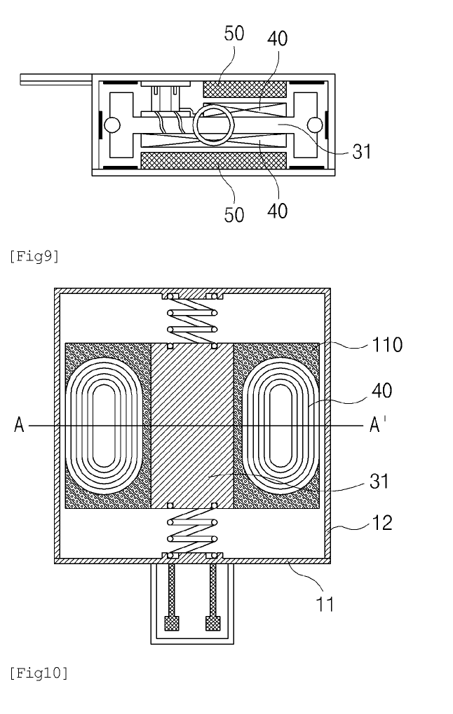

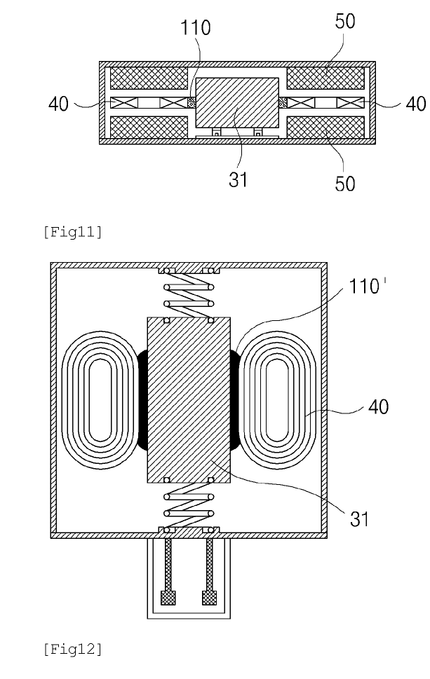

FIGS. 9 and 10 are views showing a horizontal vibration device according to another exemplary embodiment of the invention, in which FIG. 9 is a plan view, and FIG. 10 is a cross-sectional view taken along line A-A′.

Coils 40 are coupled to the left and right sides of a mass 31 via a fixing member 110, and can be coupled to be parallel to the bottom surface of a lower case 20. The fixing member 110 serves to fix the coils 40 to the mass 31, and the coils 40 are coupled to the mass 31 via the fixing member 110, which has the form of a flat panel and has defined therein spaces capable of containing the coils 40. Referring to FIG. 11, the coil 40 can be coupled to the mass 31 via a fixing member 110′, which is made of an adhesive.

In magnets 50, which are placed in a pair above and below the coils 40, one can be replaced by a magnetic material 51. Referring to FIG. 12, all magnets, which are placed above the coils 40 can be replaced with magnetic materials 51, and a magnet below the coil 40, which is coupled to one portion of the mass 31, and a magnet above the coil 40, which is coupled to the other portion of the mass 31, can be replaced with magnetic materials 51. It is preferred that the magnetic materials be made of a ferromagnetic material. Examples for the ferromagnetic material may include iron, amorphous, ferrite, and the like, and preferably is iron.

In the case in which the magnets 50 are placed in a pair above and below the coils, a strong magnetic field in which lines of magnetic force have a high density is formed. One of the magnets, which form a pair, is replaced with a magnetic material, and a magnetic circuit is still formed but the strength of the magnetic field decreases. Therefore, if a pair of magnets is replaced by magnetic materials according to the environment in which a product is used, it is possible to control the strength of the magnetic field. In addition, there is the advantage of reducing manufacturing costs, since the costs can be reduced by as much as the price of the magnet.

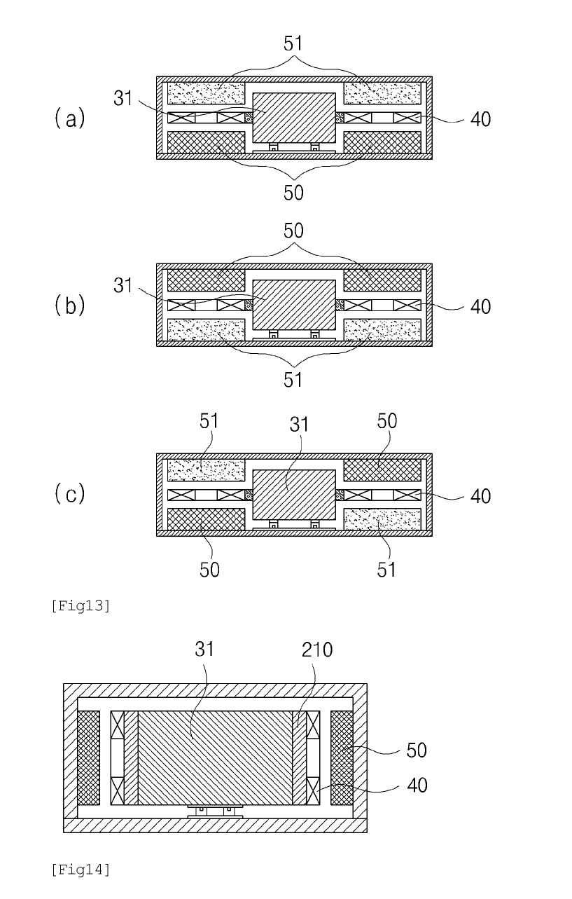

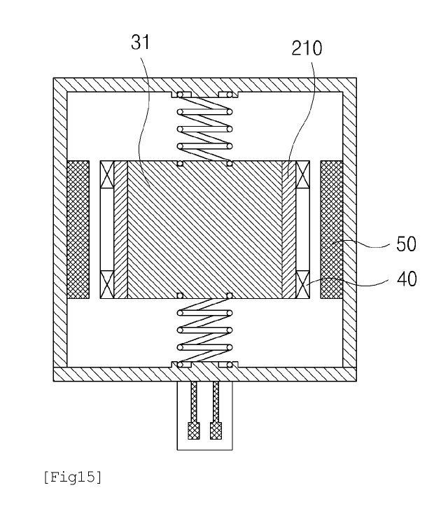

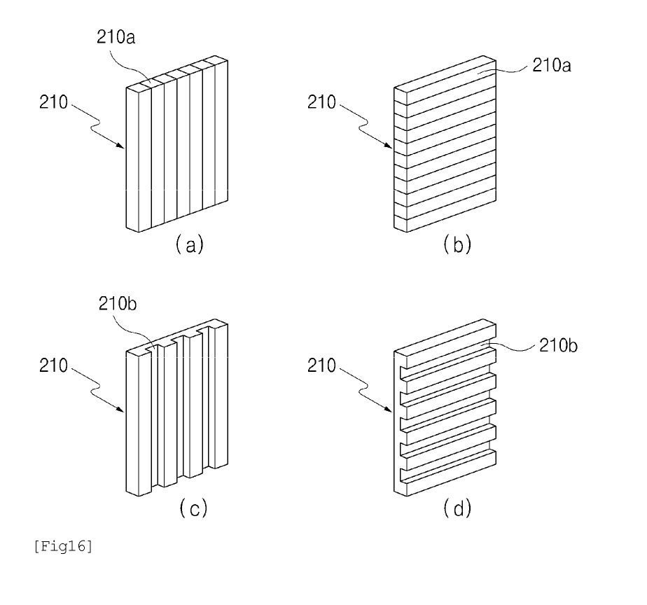

In another embodiment of the invention, the coils and the magnets can be arranged to be perpendicular to the bottom surface. Referring to FIGS. 13 and 14, the coils 40 are coupled to the left and right sides of the magnets 50, and the direction in which the mass 31 moves is perpendicular to the direction of a magnetic field that is magnetized on the magnets 50.

In this case, it is preferred that plates 210 be coupled between the mass 31 and the coils 40.

It is preferred that the plates 210 be made of a ferromagnetic material among magnetic materials, and examples for the ferromagnetic material can be iron or ferrite. The plates 210 are coupled to the rear surfaces of the coil 40 in order to maximize the efficiency of a magnetic circuit, which is formed by the coils 40 and the magnets 50.

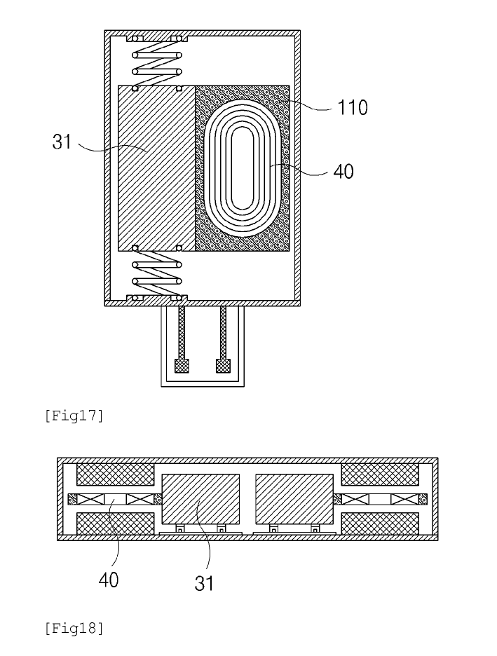

Referring to FIG. 15, each plate 210 can have a structure (a) or (b) in which a plurality of insulated cores 210a are stacked on one another, or a structure (c) and (d) in which a plurality of grooves 210b is formed.

When the coil 40 and the plate 210 perform a horizontal reciprocal motion, eddy current occurs in the plate 210 due to the magnetic field of the magnet 50. If the plate 210 has one of the structures (a) to (d) shown in FIG. 15, it is possible to minimize loss due to the eddy current.

The horizontal vibration device according to an exemplary embodiment of the invention can be modified into various forms by constructing it with different numbers of moving units and coils according to the fabrication environment thereof.

In addition, a plurality of moving units 30 can be provided in order to generate various vibration modes.

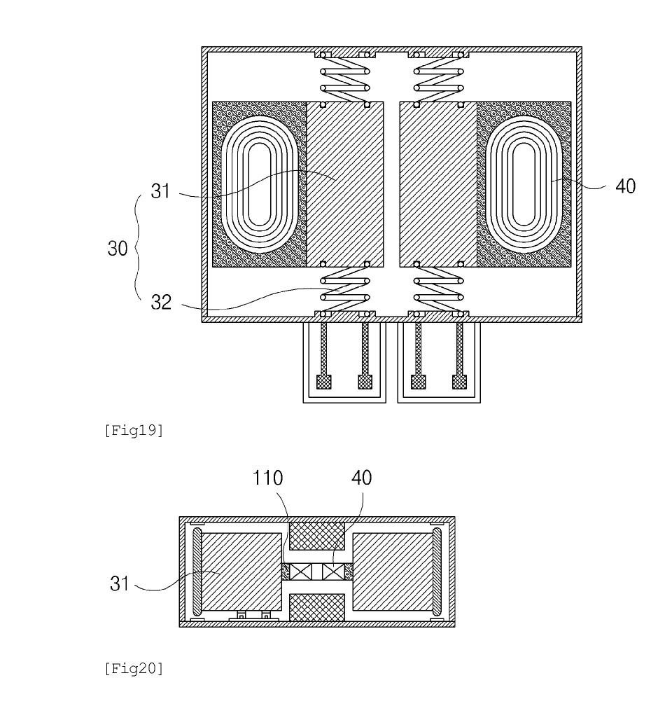

Referring to FIGS. 17 and 18, it is possible to provide a plurality of moving units 30 and attach coils 40 to one side of masses 31. The multiple masses 31 can move independently without mutual interference. In this case, a controller (not shown), which separately controls the moving units 30, can be further provided. The controller can generate various vibration modes by individually controlling the vibration characteristics (e.g., latitude, frequency, etc.) of the respective moving units 30. That is, it is possible to generate different vibration modes, for example, in a call-receiving mode, a touch mode, or a game mode of a mobile communication terminal.

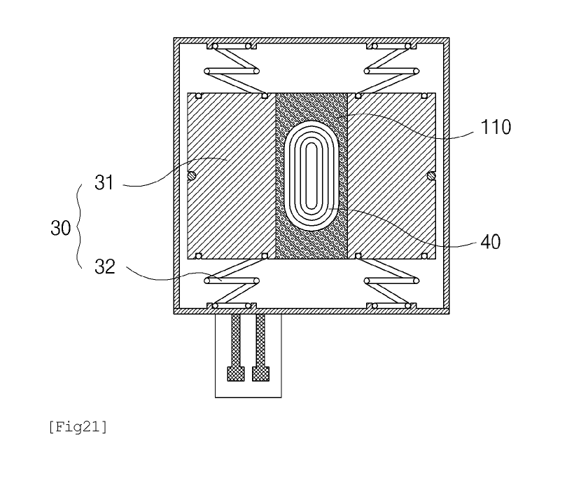

Referring to FIGS. 19 and 20, two moving units 30 are provided, and a coil 40 can be coupled between the two masses 31 via a fixing member 110. FIG. 21 is an exploded perspective view of the horizontal vibration device of this embodiment.

The horizontal vibration devices shown in FIGS. 9 to 21 are configured so that a coil-connected board is coupled to the lower portion of the mass and an external power circuit board is coupled to the bottom surface of a lower case.

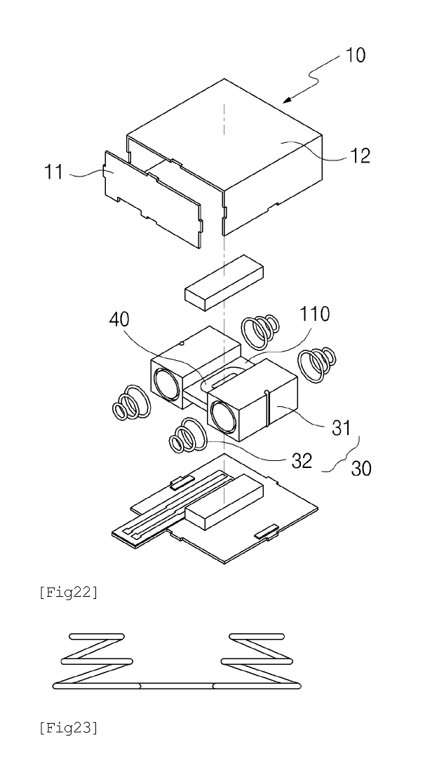

Referring to FIG. 22, in the horizontal vibration device having a plurality of moving units 30 shown in FIGS. 18 to 20, a plurality of springs can be provided in an integrated form.

In the horizontal vibration device according to an exemplary embodiment of the invention, a power supply can be disclosed in various forms. Descriptions will be given below of various embodiments, in which a power supply is coupled to a horizontal vibration device (see FIG. 21) having two moving units, with a coil coupled between two masses via a fixing member. In the following, the power supply can, of course, be applied to horizontal vibration devices according to various exemplary embodiments of the invention.

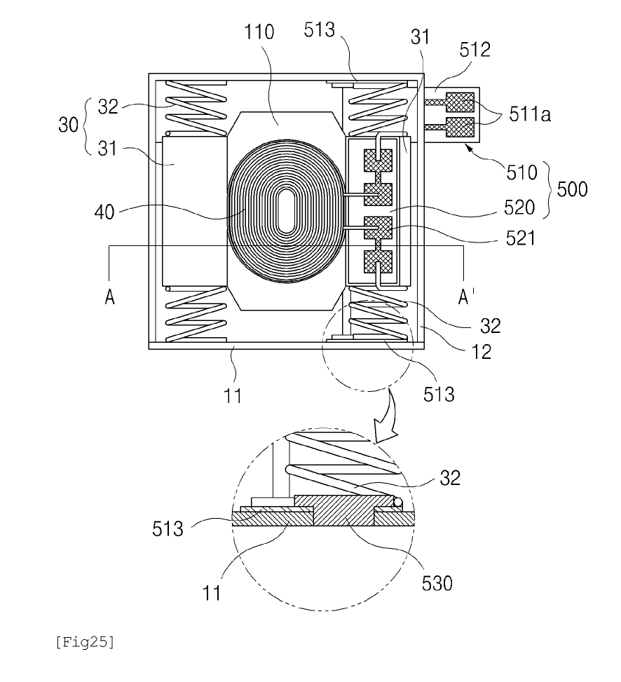

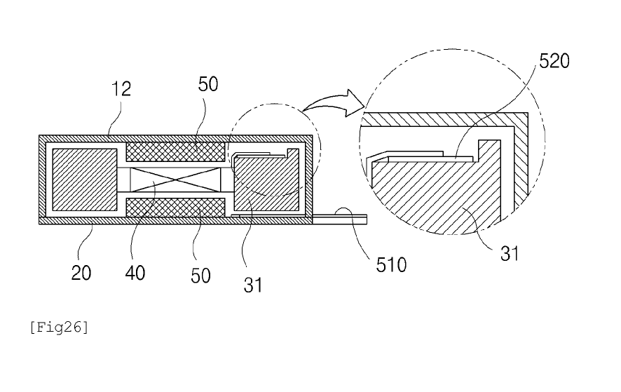

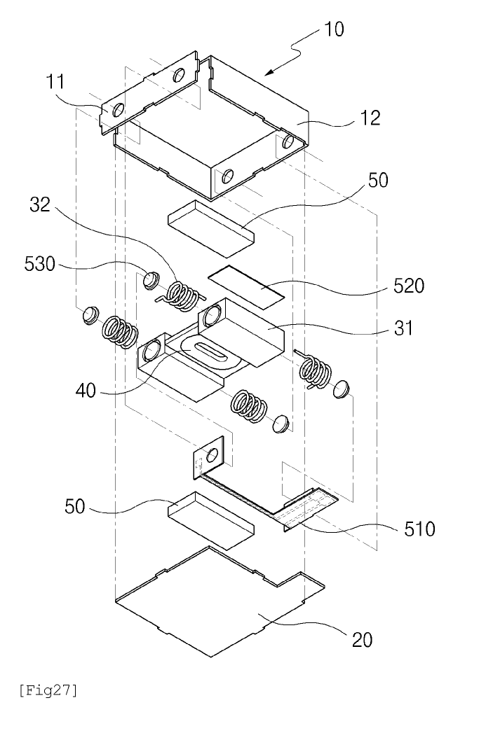

FIG. 24 is a plan view showing a horizontal vibration device according to another exemplary embodiment of the invention, FIG. 25 is a cross-sectional view taken along line A-A′ in FIG. 24, FIG. 26 is an exploded perspective view, and FIG. 27 is a view showing a spring-connected board.

A power supply 500 of the horizontal vibration device of this embodiment includes the spring-connected board 510 and a coil-connected board 520.

Referring to FIGS. 26 and 27, the spring-connected board 510 is a circuit board that includes a flat panel portion 512 and bent portions 513, which are bent from the flat panel portion 512 at an angle of 90°, and has two pattern lines 511 thereon. The bent portions 513 are coupled to the inner surface of the bracket 11 and the inner surface of the rear side of the cover 12, and the flat panel portion 512 is coupled to the inner surface of the lower case 20, thereby forming a “U” shaped structure along the inner surfaces of the upper and lower cases 10 and 20. The bent portions 513 have holes into which spring support protrusions 530 are inserted. One end 511b of the pattern lines formed on the bent portions 513 is electrically connected to one end of springs 32, and the other end 511a of the pattern lines formed on the flat panel portion 512 connected to an external power source. The springs 32 are, of course, made of a good conductor of electricity.

Referring to FIGS. 24 and 25, the coil-connected board 520 electrically connects the coil 40 to the springs 32. The coil-connected board 520 has the two pattern lines 521 thereon, and is installed on the upper portion of a mass 31. One end of the pattern lines 521 is connected to one end of the coil 40, and the other end of the pattern lines 521 is connected to one end of the springs 32. One end of the coil 40 can be connected to the pattern lines 521 by soldering or thermal fusion. It is preferred that the upper portion of the mass 31 be stepped in an “L” shaped structure in order to produce a space in which the coil-connected board 520 can be installed.

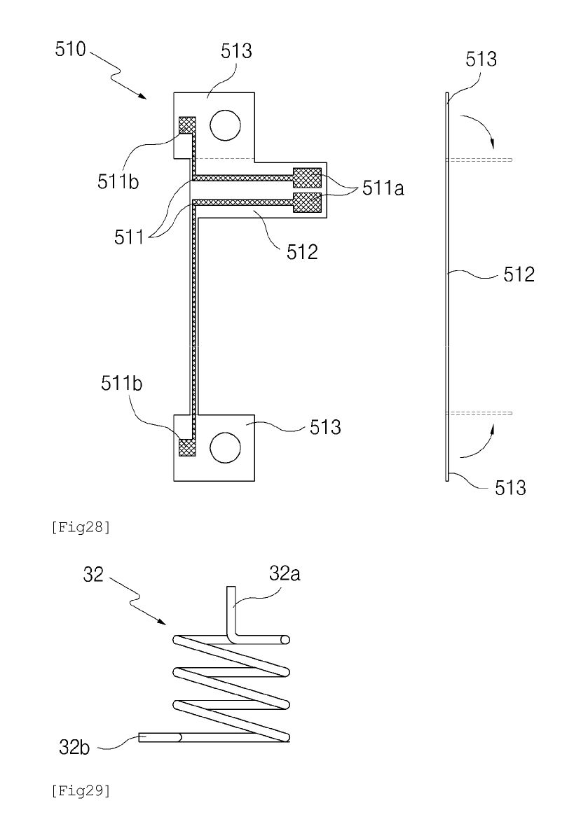

Referring to FIG. 28, it is preferred that, in both ends of the spring 32, one end 32b, which is coupled toward the cover 12, protrudes in a direction parallel to the side surface of the cover 12 and the other end 32a protrudes in the longitudinal direction of the mass 31.

In addition, it is preferably configured so that the contact portions between the springs 32 and the mass 31 and the contact portions between the springs 32 and the upper case 10 be insulated. It is preferred that spring support protrusions 530 be provided on the front surface and the rear surface of the upper case 10 in order to support the springs 32. It is preferred that the spring support protrusions 530 be made of an insulating material such as resin in order to prevent the springs 32 from being electrically connected with the upper case 10 through the spring support protrusions 530.

Since the spring-connected board 510 is present between the springs 32 and the upper case 10, the springs 32 are insulated from the upper case 10. In addition, it is preferred that an insulating coating be applied or an insulating member, such as a resin washer or an insulating tape, be provided to the portions of the mass 31, to which the springs 32 are affixed, in order to insulate the springs 32 from the mass 31. Furthermore, if the springs 32 are caused to irregularly vibrate due to external impact or the like, the springs 32 may come into contact with the upper or lower case 10 or 20. Therefore, it is preferred that the inner portions of the upper and lower cases 10 and 20 be also provided with an insulating coating in order to prevent short-circuitry from occurring.

Although it is preferred that the power supply 500 has the coil-connected board 520, one end of the coil 40 can be directly connected to the spring 32 without through the coil-connected board 520.

In the horizontal vibration device according to an exemplary embodiment of the invention, a power supply 600 includes an external power board 610, a coil-connected board 620, and elastic springs 630.

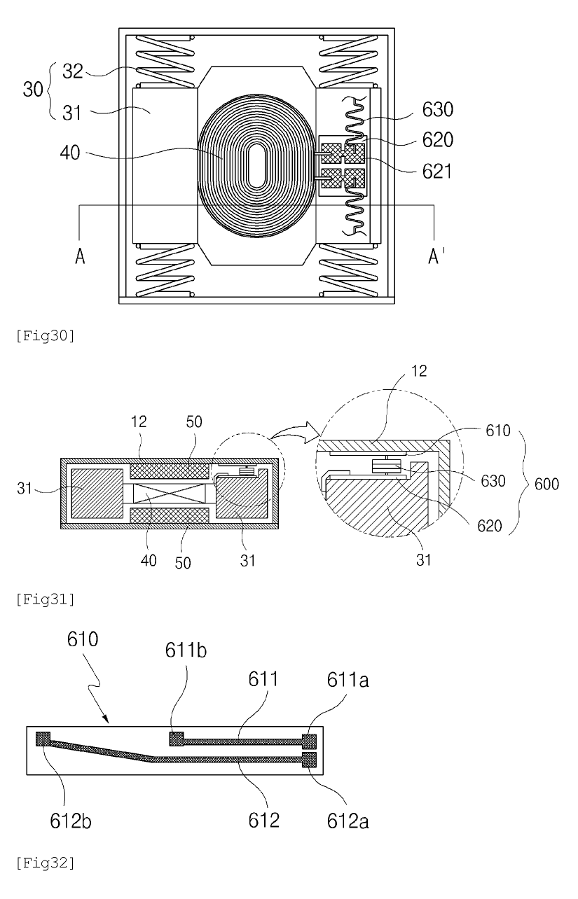

FIG. 29 is a plan view showing the horizontal vibration device according to another exemplary embodiment of the invention, FIG. 30 is a cross-sectional view taken along A-A′ in FIG. 29, and FIG. 31 is a view showing the external power board 610.

The external power board 610 is a flat panel type, and is fixedly coupled to the inner surface of the upper side of the cover 12. Referring to FIG. 31, the external power board 610 has two pattern lines 611 and 612, with one end 611a and 612a of the pattern lines being connected to a positive electrode of an external power source. In the two pattern lines, one pattern line 612 extends longer than the other pattern line 611, and one portion of the longer pattern line 612 is bent. Therefore, the two pattern lines 611b and 612b, which are connected to the elastic springs 630, are positioned collinearly. Accordingly, the elastic springs 630 can be coupled in parallel to the direction in which the mass 31 moves.

A coil 40 is electrically connected to the elastic springs 630 via the coil-connected board 620. The coil-connected board 620 has the two pattern lines 621 thereon, in which one end of each pattern line is electrically connected to one end of the coil 40, and the other end of each pattern line is connected to the elastic spring 630.

One end of the elastic springs 630 is connected to the pattern lines 621 of the coil-connected board 620, and the other end of the elastic springs 630 is connected to the pattern lines 611 and 612 of the external power board 610. The elastic spring is of course a conductor, and preferably is made of carbon steel so that it is not broken or damaged even if the mass 31 repeats a reciprocal motion.

Referring to FIG. 32, when the mass 31 performs a reciprocal motion, the elastic springs 630 in the left and right thereto perform stretching and contraction so that the electrical connection between the coil-connected board 620 and the external power board 610 can be maintained without being interrupted.

In a horizontal vibration device according to another exemplary embodiment of the invention, a power supply 700 includes an external power board 710 and an elastic circuit board 720.

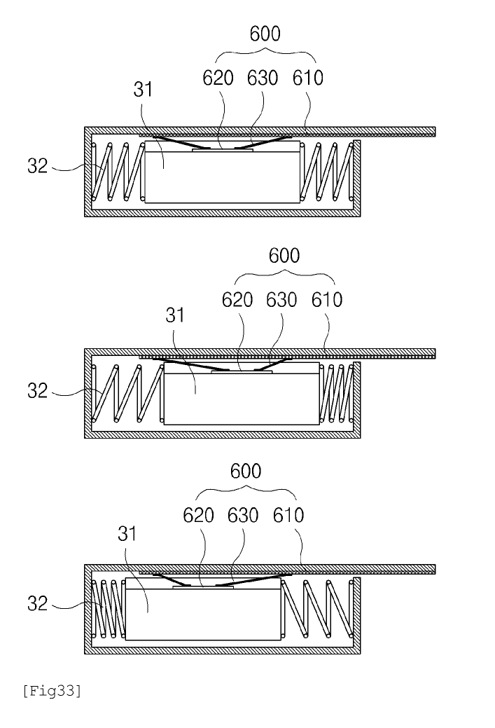

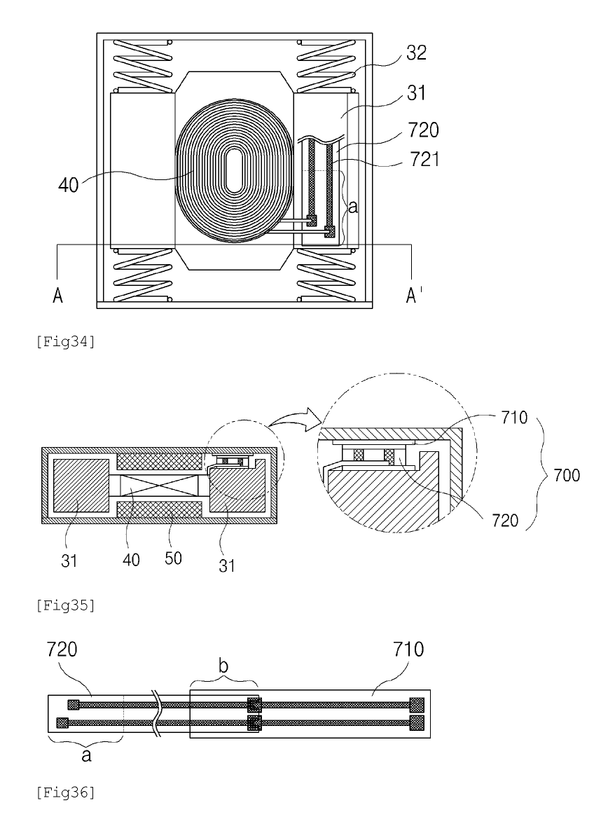

FIG. 33 is a plan view showing the horizontal vibration device according to another exemplary embodiment of the invention, FIG. 34 is a cross-sectional view taken along line A-A′ in FIG. 33, and FIG. 35 is a view showing the state in which the external power board 710 is coupled to the elastic circuit board 720.

The external power board 710 is a flat panel type, is fixedly coupled to the inner surface of the upper side of the cover 12, and is provided with two pattern lines.

The elastic circuit board 720 is a flexible board, and is provided between the external power board 710 and a mass 31 by being bent in a “U” shape. The elastic circuit board 720 has two pattern lines that extend in the longitudinal direction of the mass 31, in which one end of each pattern line is connected to each end of the coil 40, and the other end of each pattern line is connected to one end of a pattern on the external power board 710. The portion a of one side of the elastic circuit board 720 is fixedly coupled to the upper portion of the mass 31, and the portion b of the other side of the elastic circuit board 720 is fixedly coupled to the external power board 710. Therefore, the elastic circuit board 720 is not separated from the mass 31 or the external power board 710 even if the mass 31 repeats a reciprocal motion. It is preferred that layer films be attached to both surfaces of the elastic circuit board 720 in order to protect the pattern.

FIG. 36 shows an operation state of the horizontal vibration device including the power supply 700. Even if the mass 31 performs a horizontal reciprocal motion, the elastic circuit board 720 maintains the “U” shape so that the electrical connection between the external power board 710 and the coil can be maintained without being interrupted.

In a horizontal vibration device according to another exemplary embodiment of the invention, a power supply 800 includes a spring-connected board 810.

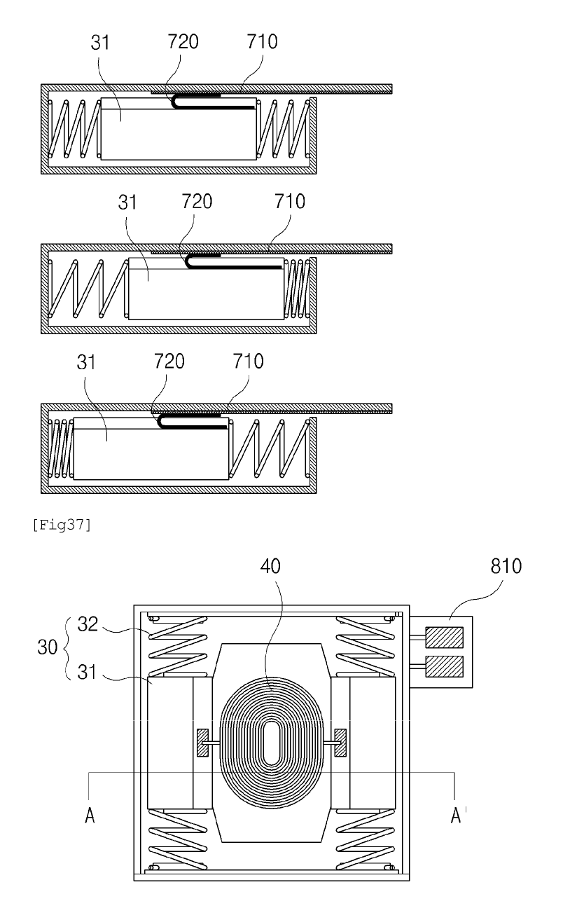

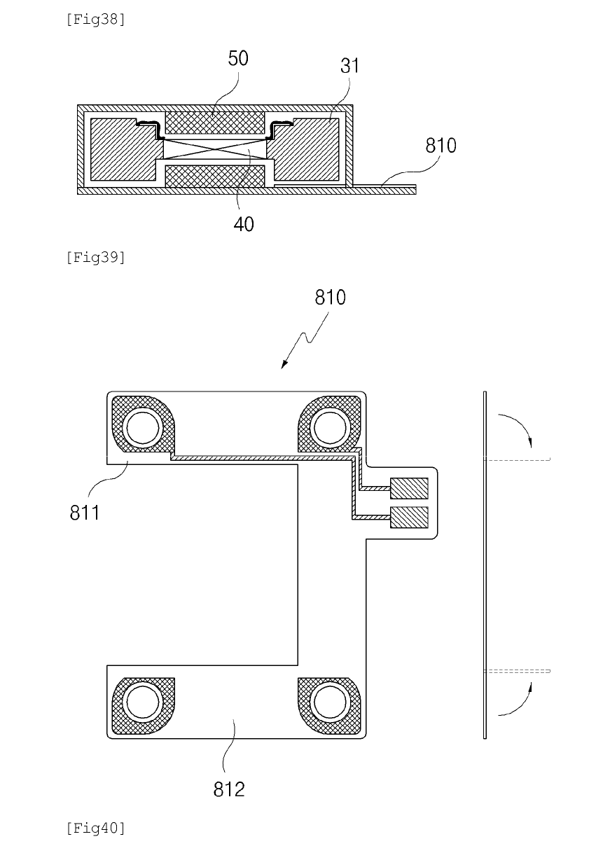

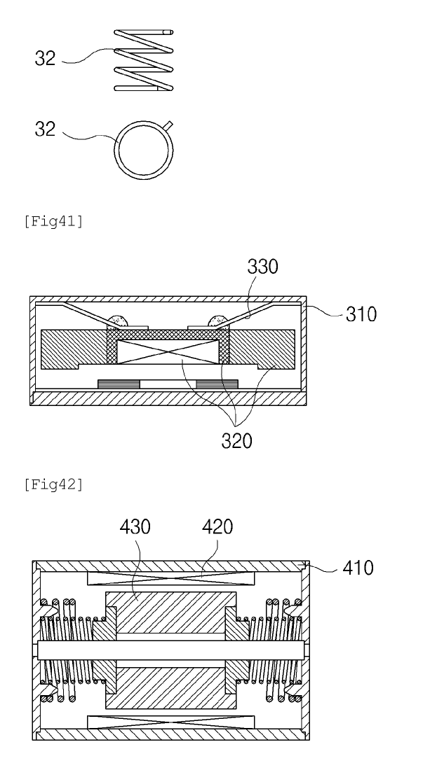

FIG. 37 is a plan view showing the horizontal vibration device according to another exemplary embodiment of the invention, FIG. 38 is a cross-sectional view taken along line A-A′ in FIG. 37, and FIG. 39 is a view showing the spring-connected board 810.

In the following, descriptions will be omitted of the components and functions the same as those of the power supply 500 described above, as well as on the insulating structure. The difference between the power supply 800 and the foregoing power supply 500 described above is that external power is supplied to the coil 40 through springs 32 and masses 31 without using the coil-connected board 510.

Referring to FIGS. 37 and 38, the spring-connected board 810 is a circuit board including a connecting portion 811 and an interrupting portion 812. The connecting portion 811 has two pattern lines thereon. One end of each pattern line on the connecting portion 811 is electrically connected to an external power source, and the other end of each pattern line is electrically connected to the springs 32. The interrupting portion 812 is not connected to the external power source, and serves to prevent current from flowing between the springs 32 and the upper case 10. The connecting portion 811 and the interrupting portion 812 have holes into which spring support protrusions 530 are inserted. The connecting portion 811 and the interrupting portion 812 can, of course, be separated from each other.

In both ends of the coil 40, one end is electrically connected to the left mass, and the other end is electrically connected to the right mass. Both ends of the coil 40 can be coupled to the masses 31 by soldering or thermal fusion.

Referring to FIG. 40, it is preferred that one end of each spring 32 protrudes so that it can be easily in contact with the pattern line on the connecting portion 811.

According to another exemplary embodiment of the invention, the power supply 800 of the horizontal vibration device is configured to operate so that external power is supplied to the coil 40 through the connecting portion 811 of the spring-connected board 810 and through the springs 32 and the masses 31, which are conductors.

Therefore, since power is supplied to the coil 40 through the masses 31, it can be understood that the masses 31 can, of course, be made of a conductor, and preferably be made of tungsten.

Alternatively, portions of the surfaces of the masses 31 can be coated with a metallic material, such as Zn, Ni, or Sn, so that current can flow through the masses 31.

Although the power supply 800 has been described as being applied to the horizontal vibration device, with the masses 31 thereof being coupled to both sides of the coil 40, in the foregoing embodiment, the power supply 800 can, of course, be applied to a horizontal vibration device having one mass if the mass is divided into half sections that are insulated from each other.

The spring-connected boards 510 and 810, the external power board 610 and 710, and the coil-connected boards 520 and 620 can be a hard or flexible board.

While the present invention has been shown and described with reference to the certain exemplary embodiments thereof and the accompanying drawings, the present invention is by no means limited thereto. It will be understood by those skilled in the art that various modifications, changes, and variations can be made therein without departing from the spirit and scope of the present invention and within the scope of the appended claims and the equivalents thereof.

1. A horizontal vibration device comprising:
an upper case (10) having a spring connector (10a) in an inner surface thereof and a lower case (20), wherein the lower case (20) is coupled to the upper case (10) to define a space therein;
a moving unit (30) including a mass (31) for performing a horizontal reciprocal motion inside the upper and lower cases (10, 20) and springs (32) coupled between the upper and lower case (10, 20) and the mass (31) to support a parallel motion of the mass (31);
a coil (40) coupled to the mass (31) to perform a horizontal reciprocal motion along with the mass (31);
magnets (50) fixedly coupled to inner surfaces of the upper and lower cases (10, 20) to interact with the coil (40); and
a power supply (60, 500, 600, 700, 800) for supplying power to the coil (40).

2. The horizontal vibration device according to claim 1, wherein the upper case (10) includes a cover (12) and a bracket (11).

3. The horizontal vibration device according to claim 1, wherein the upper case (10) and the lower case (20) are “U” shaped, and are coupled in a staggered arrangement by an interactive force between the magnets (50) coupled to the upper case (10) and the lower case (20).

4. The horizontal vibration device according to claim 3, wherein the upper case (10) and the lower case (20) are provided with a coupling protrusion (10c, 20c) and a coupling recess (10d, 20d).

5. The horizontal vibration device according to claim 1, wherein spring connectors (31a) are formed on front and rear surfaces of the mass (31).

6. The horizontal vibration device according to claim 1, wherein the mass (31) has a guide groove therein,
the horizontal vibration device further comprising a guide (33) coupled to the guide groove.

7. The horizontal vibration device according to claim 1, wherein the mass (31) has a protrusion-shaped guide (33) thereon.

8. The horizontal vibration device according to claim 6, wherein the guide (33) is coupled in a direction parallel to a direction in which the mass (31) moves.

9. The horizontal vibration device according to claim 6, wherein the guide (33) is coupled in a direction perpendicular to a direction in which the mass (31) moves.

10. The horizontal vibration device according to claim 6, wherein the guide (33) is bar shaped.

11. The horizontal vibration device according to claim 6, wherein the guide (33) is spherical.

12. The horizontal vibration device according to claim 1, further comprising a preventive member (70) for preventing friction and resultant noise between the mass (31) and the inner surfaces of the upper and lower cases (10, 20).

13. The horizontal vibration device according to claim 1, wherein the coil (40) is coupled to one or both sides of the mass (31) via a fixing member (110, 110′) so that the coil (40) is parallel to a bottom surface of the lower case (20), and the magnets (50) are coupled so as to face the coil (40).

14. The horizontal vibration device according to claim 13, wherein the magnet (50) is coupled to the inner surfaces of the upper and lower cases (10, 20), and a pair of the magnets (50) are arranged above and below the coil (40).

15. The horizontal vibration device according to claim 14, wherein one of the pair of the magnets (50) is a magnetic material.

16. The horizontal vibration device according to claim 1, wherein the coil (40) is coupled to both sides of the mass (31) so as to be parallel to a bottom surface of the lower case (20), and the magnets (50) are coupled so as to face the coil (40).

17. The horizontal vibration device according to claim 16, further comprising a plate (210) coupled between the coil (40) and the mass (31) to interrupt lines of magnetic force that are generated by the coil (40).

18. The horizontal vibration device according to claim 17, wherein the plate (210) is a magnetic material.

19. The horizontal vibration device according to claim 1, wherein the power supply (60) includes an external power board (61) connected to an external power source, a coil-connected board (62) installed on the mass (31) and electrically connected to the coil (40), and a brush (63) electrically connecting the external power board (61) to the coil-connected board (62).

20. The horizontal vibration device according to claim 19, wherein the brush (63) includes a flat fixing portion (63a) fixed to the external power board (61), an arc-shaped bent (63b) beginning from one end of the fixing portion (63a), and a contact (63d) having a plurality of prongs, the contact (63d) being in contact with the coil-connected board (62).

21. The horizontal vibration device according to claim 20, wherein an arc defined by the bent (63b) has an angle of circumference (8) ranging from 90° to 180°.

22. The horizontal vibration device according to claim 1, further comprising a fixing member (110) fixing the coil (40) to the mass (31), and a damper (80) for preventing the coil (40) or the mass (31) from colliding into the case (10, 20).

23. The horizontal vibration device according to claim 13 comprising a plurality of the moving units (30), wherein the coil (40) is coupled to one portion of an outermost one of a plurality of the masses (31).

24. The horizontal vibration device according to claim 13, comprising a plurality of the moving units (30), wherein the coil (40) is coupled between a plurality of the masses (31) through a fixing member (110, 110′).

25. The horizontal vibration device according to claim 23, further comprising a controller for individually controlling the moving units (30), wherein the masses (31) are individually moved by the controller.

26. The horizontal vibration device according to claim 24, wherein springs included in the moving units (30) are integrally formed.

27. The horizontal vibration device according to claim 1, wherein the power supply (500) includes a spring-connected board (510) electrically connected to a spring (32) to supply external power to the coil (40) through the spring (32), and a coil-connected board (520) coupled to the mass (31) and electrically connected to the coil (40).

28. The horizontal vibration device according to claim 27, wherein the spring-connected board (510) has a “U” shape, with both end portions thereof being bent, and is coupled to the inner surfaces of the upper and lower cases (10, 20).

29. The horizontal vibration device according to claim 27, wherein the spring (32) has protruding both ends (32a, 32b), whereby the spring (32) is easily in contact with patterns (511, 521) of the spring-connected board (510) and the coil-connected board (520).

30. The horizontal vibration device according to claim 27, further comprising a spring support protrusion (530) coupled to the upper case (10) to support the spring (32), wherein the spring support protrusion (530) is made of a resin material that insulates the spring (32) and the upper case (10).

31. The horizontal vibration device according to claim 1, wherein the power supply (600) includes an external power board (610) connected to an external power source, a coil-connected board (620) installed on the mass (31) and electrically connected to the coil (40), and an elastic spring (630), wherein one end of the elastic spring (630) is connected to the external power board (610), and the other end of the elastic spring (630) is connected to the coil-connected board (620).

32. The horizontal vibration device according to claim 31, wherein the external power board (610) has two pattern lines (611, 612) having different lengths, one end (611b) of the pattern line (611) being positioned collinear with one end (612b) of the pattern line (612).

33. The horizontal vibration device according to claim 31, wherein the elastic spring (630) is made of carbon steel.

34. The horizontal vibration device according to claim 1, wherein the power supply (700) includes an external board (710) connected to an external power source, and an elastic circuit board (720), wherein a portion of the elastic circuit board (720) is fixedly connected to the mass (31), and the elastic circuit board (720) supplies external power that is supplied through the external board (710) to the coil (40).

35. The horizontal vibration device according to claim 34, wherein the elastic circuit board (720) has layer films attached to both surfaces thereof in order to protect a pattern thereof.

36. The horizontal vibration device according to claim 1, wherein the power supply (800) includes a spring-connected board (810) electrically connected to a spring (32) to supply external power to the mass (31) through the spring (32), wherein the mass (31) is electrically connected to the spring (32), so that the external power that is supplied through the spring (32) is supplied to the coil (40) through the mass (31).

37. The horizontal vibration device according to claim 36, wherein the mass (31) is a conductor.

38. The horizontal vibration device according to claim 36, wherein the spring-connected board (810) includes a connecting portion (811) and an interrupting portion (812), and is coupled to the inner surfaces of the upper and lower cases (10, 20).

39. The horizontal vibration device according to claim 36, wherein both ends of the coil (40) are connected to the mass (31) by soldering or thermal fusion.
